(19) United States
(12) Patent Application Publication
(10) Pub. No.: US 2007/0251969 A1
(43) Pub. Date: Nov. 1, 2007

(54) MACHINE WITH A STRIP NAILER

(76) Inventor: Karl Weinmann, St. Johann (DE)

Correspondence Address: STRIKER, STRIKER & STENBY, 103 EAST NECK ROAD, HUNTINGTON, NY, 11743, US

(21) Appl. No.: 11/693,798

(22) Filed: Mar. 30, 2007

(30) Foreign Application Priority Data
Apr. 27, 2006 (DE) 10 2006 020 229.5

(51) Int. Cl. B25C 5/06

(52) U.S. Cl. 227/120

(57) ABSTRACT

In a machine, in particular for woodworking, that is equipped with a strip nailer, which can be moved relative to a work piece and/or a work piece support and which has a nail strip magazine, the machine is associated with an auxiliary magazine for storing a number of nail strips and it is possible to move the strip nailer, together with its nail strip magazine, into the region of the auxiliary magazine. This permits the nail strip magazine to be filled more quickly.

### CROSS-REFERENCE TO A RELATED APPLICATION

The invention described and claimed hereinbelow is also described in German Patent Application DE 10 2006 020 229.5 filed on Apr. 27, 2006. This German Patent Application, whose subject matter is incorporated here by reference, provides the basis for a claim of priority of invention under 35 U.S.C. 119(a)-(d).

### BACKGROUND OF THE INVENTION

The invention relates to a machine, in particular for woodworking, that is equipped with a strip nailer, which can be moved relative to a work piece and/or a work piece support and which has a nail strip magazine; the invention also relates to a method for filling a nail strip magazine of a strip nailer of a machine.

There are known woodworking machines with which wood components can be fastened to each other by means of nails. Usually, so-called strip nailers are used for this, which have a nail strip magazine containing nails that are attached to a strip. Due to the force of gravity, the nail strip advances each time a nail is driven in. If the nail strip is finished, i.e. the nail strip magazine is empty, then the strip nailer travels into a certain position in which it is filled manually with another nail strip. This interrupts the work process.

In order to minimize interruptions to the greatest possible extent, it is known, as an alternative to a strip nailer, to use a so-called “coil” nailer in which the nails are not stored in nail strips, but are instead stored in rolls.

### SUMMARY OF THE INVENTION

The object of the present invention is to modify a machine of the type mentioned at the beginning in such a way that the nail strip magazine can be filled in a simpler, quicker fashion.

This object is attained according to the invention in a particularly simple and surprising manner by virtue of the fact that a machine of the type mentioned at the beginning is associated with an auxiliary magazine for storing a number of nail strips; the strip nailer, together with its nail strip magazine, can be moved into the region of the auxiliary magazine.

Preferably, the nail strip magazine travels into a position underneath the auxiliary magazine so that the force of gravity causes a nail strip to drop into the nail strip magazine. The auxiliary magazine can be filled while the machine is in operation. The filling can be carried out manually or can occur in an automated fashion. If the nail strip magazine is filled during existing work gaps in the nailing process, then this enables continuous operation. The machine can be embodied as a portal machine onto whose work piece support a work piece can be placed, in particular a work piece made of wood, such as a beam or a board.

In essence, it is sufficient for the auxiliary magazine to be situated in the region of the machine. It is particularly advantageous, however, if the auxiliary magazine is situated on the machine.

In a preferred embodiment, it is possible for the auxiliary magazine to have a nail strip lock that can be brought into a release position, particularly in opposition to a restoring force. As long as the nail strip magazine is not situated in the region of the auxiliary magazine, the nail strip lock prevents the nail strip from dropping out of the auxiliary magazine. But when the nail strip magazine is situated in the region of the auxiliary magazine, the nail strip lock is moved into a release position so that a nail strip can drop into the nail strip magazine. As soon as this has occurred, the nail strip lock returns to the locked position, preferably automatically, for example in a spring-loaded fashion.

It is conceivable for the nail strip lock to be triggered by a machine control unit and therefore to open and close at the right times. An alternative embodiment features a nail strip magazine that can move the nail strip lock into a release position.

It is particularly preferable if the auxiliary magazine is equipped with compartments for the nail strips. This keeps the nail strips separate from one another and makes it possible to assure that they do not hinder one another so that a nail strip is always able to fall unimpeded into the nail strip magazine.

In a particularly preferred embodiment, it is possible for an advance mechanism to be provided for the nail strips contained in the auxiliary magazine. This is particularly advantageous if the nail strip magazine is always moved into the same filling position. The provision of the advance mechanism makes it possible to assure that a nail strip is always in this filling position, thus permitting the nail strip magazine to be filled.

In one modification, it is possible for the compartments of the auxiliary magazine and/or for the auxiliary magazine itself to be moved in relation to a filling position. This permits the nail strips stored in the auxiliary magazine to be transported.

If the auxiliary magazine is open on at least one side, then the auxiliary magazine is particularly easy to fill with nail strips. Depending on the embodiment of the auxiliary magazine, the auxiliary magazine can be open either at the top or on a side, for example the back side.

In one embodiment of the invention, the height of the auxiliary magazine can be less than the height of the nail strip magazine. This allows the auxiliary magazine to be situated in a space-saving fashion and also makes it suitable for accommodating nail strips that are shorter in length than the height of the nail strip magazine. It is thus possible to already fill the nail strip magazine with another nail strip when the preceding nail strip is not yet completely spent. This measure makes it possible to implement an at least approximately continuous work process. In particular, work does not have to be interrupted due to an empty nail strip magazine.

In one embodiment, the auxiliary magazine or only part of the auxiliary magazine can be embodied in the form of a circular arrangement. In order to move the nail strip into the filling position, either the entire magazine can be supported in rotating fashion or a circular arrangement containing the compartments can be rotated in a circle inside the auxiliary magazine.

In an alternative embodiment, the auxiliary magazine can be embodied in a block shape. An auxiliary magazine embodied in this way is preferably able to move in a grid pattern along its longitudinal direction in order to assure that a nail strip is always in the filling position.

The scope of the invention also includes a method for filling a nail strip magazine of a strip nailer of a machine, in particular for woodworking, in which the nail strip magazine is moved into a filling position underneath an auxiliary magazine. This measure means that the nail strip magazine is refilled almost independently of the machine operator. This makes it possible to minimize, if not entirely eliminate, down times of the machine.

According to one method variant, when an empty nail strip magazine is detected, the nail strip magazine is moved into the filling position. This assures that there is always a sufficient supply of nails.

It is particularly advantageous, however, if the nail strip magazine is moved into the filling position and filled during a pause in the nailing process. This allows the nail strip magazine to be refilled before it has been completely emptied. If the filling is carried out during a pause in the nailing process, it is not necessary to interrupt the work on a work piece in order to fill the nail strip magazine. The nail strip magazine can be filled during the execution of other machining steps.

In one method variant, a nail strip lock can be moved into a release position when the nail strip magazine is in the filling position. Preferably this occurs in an automated fashion without requiring action by the operating personnel.

If the nail strip lock is actuated by the nail strip magazine, then it is possible to assure that the nail strip lock is transferred into a release position at the right time. This optimizes the timing of the filling process.

Other defining characteristics and advantages of the invention are demonstrated in the following detailed description of exemplary embodiments of the invention, in conjunction with the figures in the drawings that show details essential to the invention, and in the claims. In variants of the invention, the individual defining characteristics can be implemented individually or can be united in any combination.

Exemplary embodiments of the invention are depicted in the schematic drawings, which will be explained in detail in the description that follows.

### BRIEF DESCRIPTION OF THE DRAWINGS

FIG. 1 is a section through a strip nailer equipped with a nail strip magazine in accordance with the present invention;

FIG. 2 is a sectional depiction of the strip nailer in a filling position underneath an auxiliary magazine in accordance with the present invention;

FIG. 3 is a top view of the auxiliary magazine in accordance with the present invention.

### DESCRIPTION OF THE PREFERRED EMBODIMENTS

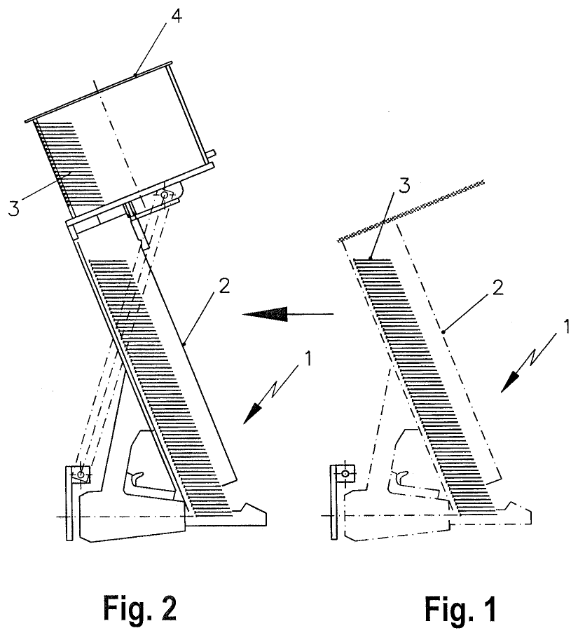

FIG. 1 shows a strip nailer 1 of a woodworking machine, which has a nail strip magazine 2 containing a nail strip 3. The force of gravity causes the nail strip 3 to advance when a nail is used (removed) at the bottom end.

In order to fill the nail strip magazine 2, the strip nailer 1 moves into a filling position shown in FIG. 2. In this filling position, the strip nailer 1 is situated with its nail strip magazine 2 underneath an auxiliary magazine 4 in which nail strips 3 are stored. In the filling position depicted, a nail strip lock that is not shown in the figure is moved into a release position so that a nail strip 3 can drop into the nail strip magazine 2 due to the force of gravity. It is clear that the height of the auxiliary magazine 4 is less than the height of the nail strip magazine 2. Consequently, the nail strips 3 are also shorter than the height of the nail strip magazine 2. As a result, the nail strip magazine 2 can be filled with several nail strips 3. In particular, the nail strip magazine 2 can already be filled with a new nail strip 3 when a preceding nail strip 3 is not yet completely spent.

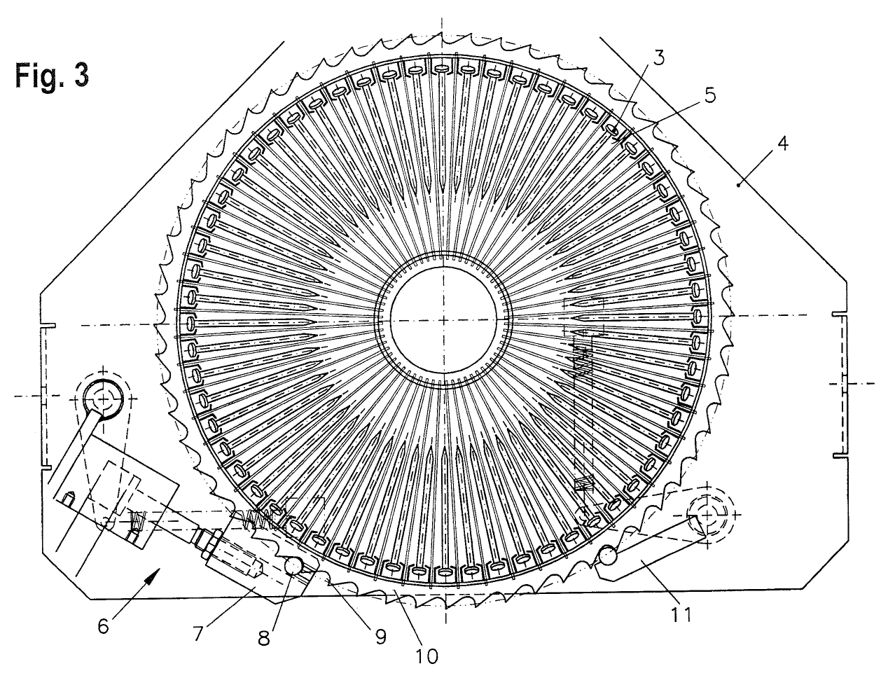

FIG. 3 is a top view of the auxiliary magazine 4 that is open at the top. In the exemplary embodiment, the auxiliary magazine 4 is embodied in the form of a circular arrangement 10 or is equipped with such an arrangement. This circular arrangement has a number of compartments 5 arranged in a circle, each of which contains a nail strip 3.

The arrangement of the compartments 5 together with the nail strips 3 can be rotated counterclockwise inside the auxiliary magazine 4 by means of an advance mechanism 6. The advance mechanism 6 has an arm 7 on which a bolt 8 is situated, which engages in recesses 9. A movement of the arm 7 can cause the circular arrangement 10 and therefore the compartments 5 to rotate. A reverse rotation is prevented by a catch 11, which can be pivoted out counter to a restoring force when the arrangement 10 is rotated counterclockwise.

By rotating the circular arrangement 10, it is possible to assure that a nail strip 3 is always situated in a filling position.

The filling position of the auxiliary magazine is also a position in which a compartment 5 is situated so that the force of gravity causes a nail strip 3 contained therein to travel into a nail strip magazine 2 situated underneath it when the nail strip lock is released. The filling position of the nail strip magazine is the position in which the nail strip magazine 2 is situated underneath the auxiliary magazine 4, in particular flush with a compartment 5.

It will be understood that each of the elements described above, or two or more together, may also find a useful application in other types of constructions differing from the type described above.

While the invention has been illustrated and described as embodied in a machine with a strip nailer, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A machine, comprising a strip nailer movable relative to an element selected from the group consisting of a workpiece, a workpiece support, and both; a nail strip magazine; and an auxiliary magazine for storing a number of nails, said strip nailer together with said nail strip magazine being movable into a region of said auxiliary magazine.

2. A machine as defined in claim 1, wherein said auxiliary magazine is arranged so that it is situated on a machine.

3. A machine as defined in claim 1, wherein said auxiliary magazine has a nail strip lock that is movable into a release position.

4. A machine as defined in claim 3, wherein said nail strip lock of said auxiliary magazine is movable into the release position in opposition to a restoring force.

5. A machine as defined in claim 3, wherein said nail strip magazine is configured so as to move said nail strip lock into a release position.

6. A machine as defined in claim 1, wherein said auxiliary magazine has compartments for nail strips.

7. A machine as defined in claim 1; and further comprising an advance mechanism for the nail strips, contained in said auxiliary magazine.

8. A machine as defined in claim 6, wherein said compartments of said auxiliary magazine are movable relative to a filling position.

9. A machine as defined in claim 1, wherein said auxiliary magazine is movable relative to a filling position.

10. A machine as defined in claim 1, wherein said auxiliary magazine is open on at least one side.

11. A machine as defined in claim 1, wherein said auxiliary magazine has a height which is less than a height of said nail strip magazine.

12. A machine as defined in claim 1, wherein said auxiliary magazine is configured as a circular arrangement.

13. A machine as defined in claim 1, wherein said auxiliary magazine has a part which is configured as a circular arrangement.

14. A machine as defined in claim 1, wherein said auxiliary magazine is configured as a magazine having a block shape.

15. A machine as defined in claim 1, wherein said nail strip magazine is movable into a filling position underneath said auxiliary magazine.

16. A machine as defined in claim 1, wherein said nail strip magazine is movable into a filling position when it is determined that said nail strip magazine is empty.

17. A machine as defined in claim 1, wherein said nail strip magazine is moved into a filling position and filled during a pause in a nailing process.

18. A machine as defined in claim 1; and further comprising a nail strip lock which is movable into a release position when said nail strip magazine is in a filling position.

19. A machine as defined in claim 1, wherein said auxiliary magazine has a nail strip lock actuated by said nail strip magazine.

20. A machine as defined in claim 1, wherein said magazines are configured so that after a filling of said nail strip magazine, a nail strip in said auxiliary magazine is moved into a filling position.

21. A machine as defined in claim 1, wherein the machine is configured for wood working.
